(19) United States
(12) Patent Application Publication
(10) Pub. No.: US 2005/0190249 A1
(43) Pub. Date: Sep. 1, 2005

(54) Roller for use with substrates bearing printed ink images and a composition for coating the roller

(76) Inventors: Jiann-Hsing Chen, Fairport, NY (US); Joseph A. Pavlisko, Pittsford, NY (US); Robert A. Lancaster, Hilton, NY (US); Po-Jen Shih, Webster, NY (US)

Correspondence Address: Paul A. Leipold;Eastman Kodak Company, Patent Legal Staff, 343 State Street, Rochester, NY, 14650-2201, US

(21) Appl. No.: 11/054,422

(22) Filed: Feb. 9, 2005

Related U.S. Application Data
(60) Provisional application No. 60/543,072, filed on Feb. 9, 2004.

(51) Int. Cl. C09D 11/00

(52) U.S. Cl. 347/103

(57) ABSTRACT

A roller composition for forming an outer coating on the roller. The composition includes an addition cure polysiloxane component and a high molecular weight reactive polyfunctional poly(alkylsiloxane) component. The coated roller is effective for drying and fusing ink images on a substrate.

### CROSS-REFERENCE TO RELATED APPLICATION

Reference is made to the co-pending, commonly assigned, U.S. Provisional Patent Application Ser. No. 60/543,072 filed on Feb. 9, 2004, entitled: ROLLER FOR USE WITH SUBSTRATES BEARING PRINTED INK IMAGES AND A COMPOSITION FOR COATING THE ROLLER, the disclosure of which is incorporated herein by reference.

### FIELD OF THE INVENTION

This invention relates to printer rollers coated with a composition for treating ink image-bearing substrates to improve various properties of the ink image-bearing substrate.

### BACKGROUND OF THE INVENTION

Ink jet printing is a non-impact printing method which in response to a digital signal produces drops of ink deposited on a recording element or substrate. Ink jet printing systems are used in a variety of capacities in industrial, home and office environments. The quality of ink jet prints and other ink prints continues to improve, however, the ink jet prints are disadvantaged because they lack durability, often being less stable relative to environmental factors of light, ozone, etc and more sensitive to water and abrasion. Various ways of overcoming these disadvantages have been used. Ink jet prints have been laminated using a transparent overlay that may be adhered to the ink jet print. The laminating sheets may be adhered directly to the substrate by heat, pressure or both.

Another alternative is the use of substrates that have a nascent protective layer coated on the substrate. During the ink jet printing process, the inks penetrate the layer and after penetration is complete, the layer is fused using heat, pressure or both to seal and protect the print. The ink jet recording material may include a porous top layer that can be thermally fixed after the image has been printed on the substrate. Various other techniques have been used to more firmly fix the ink jet image onto the substrate. In some instances, inks containing fusable polymer constituents have been used. These fusable polymer constituents may be fused to improve the stability of the printed image. Unfortunately, when equipment that is used to fuse toner images produced by electrophotographic copying is used for this application, the release of the images from the roller surfaces is not satisfactory.

Further, rollers or the like may be used in attempts to dry ink jet images to reduce the solvent or moisture content of such images either alone or in conjunction with the fusing operations to produce more durable printed images on a substrate.

Accordingly, a continuing effort have been made toward the development of rollers and other equipment which may be used to treat ink jet or other ink images on a substrate to improve the durability and other properties of the ink images on the substrate.

### SUMMARY OF THE INVENTION

The present invention comprises a roller for use in treating a recording element (substrate) bearing a printed or an ink image to improve at least one property of the ink image on the recording element, the roller comprising a metallic core having an outside and an outer coating around the outside of the metallic core and comprising a reaction product of: a high molecular weight reactive polyfunctional poly(alkylsiloxane) polymer which is a liquid blend at room temperature (25 C) comprising from about 60 to about 80 weight percent of a difunctional poly(dialkylsiloxane) polymer having a number average molecular weight from about 140,000 to about 150,000 and about 20 to about 40 weight percent of a poly(trialkyl)silyl silicate resin having monofunctional and tetrafunctional repeating units in an average ratio of between 0.8 to about 1 monofunctional unit per each tetrafunctional unit (0.8-1.0:1.0) to 1, and having a number average molecular weight of about 1,500 to about 2,500 at least one cross-linkable vinyl-substituted poly(dialkylsiloxane) with a weight-average molecular weight before cross-linking of about 1,000 to about 90,000; about 1 to about 5 parts by weight per 100 parts by weight of poly(dialkylsiloxane) finely divided filler; at least one cross-linking agent comprising a multifunctional organo-hydrosiloxane cross-linking agent having hydride functional groups capable of reacting with the vinyl functional groups of the vinyl-substituted poly(dialkylsiloxane); and at least one cross-linking catalyst present in an amount sufficient to catalyze addition polymerization of the vinyl-substituted poly(dialkylsiloxane) and the cross-linking agent.

The present invention further comprises a composition comprising a reaction product of: a high molecular weight reactive polyfunctional poly(alkylsiloxane) polymer which is a liquid blend at 25 C comprising from about 60 to about 80 weight percent of a difunctional poly(dialkylsiloxane) polymer having a number average molecular weight from about 140,000 to about 150,000 and about 20 to about 40 weight percent of a poly(trialkyl)silyl silicate resin having monofunctional and tetrafunctional repeating units in an average ratio of between 0.8 to about 1 monofunctional unit per each tetrafunctional unit (0.8-1.0) to 1 and having a number average molecular weight from about 1,500 to about 2,500; at least one cross-linkable vinyl-substituted poly(dialkylsiloxane) with a weight-average molecular weight before cross-linking of about 1,000 to about 90,000; about 1 to about 5 parts by weight per 100 parts by weight of polydiaklysiloxane finely divided filler; at least one cross-linking agent comprising a multifunctional organo-hydrosiloxane having hydride functional groups capable of reacting with the vinyl functional groups of the vinyl-substituted poly(dialkylsiloxane); and at least one cross-linking catalyst present in an amount sufficient to catalyze addition polymerization of the vinyl-substituted poly(dialkylsiloxane) and the cross-linking agent.

### BRIEF DESCRIPTION OF THE DRAWINGS

FIG. 1 is a schematic diagram of an embodiment of the present invention in combination with other elements of an ink image drying system and an ink jet fusing system.

FIG. 2 is a cross-sectional view of an embodiment of a roller according to the present invention for treating a recording element bearing an ink image; and,

FIG. 3 is a cross-sectional view of an alternate embodiment of a roller for use in treating a recording element bearing an ink image.

### DETAILED DESCRIPTION OF THE INVENTION

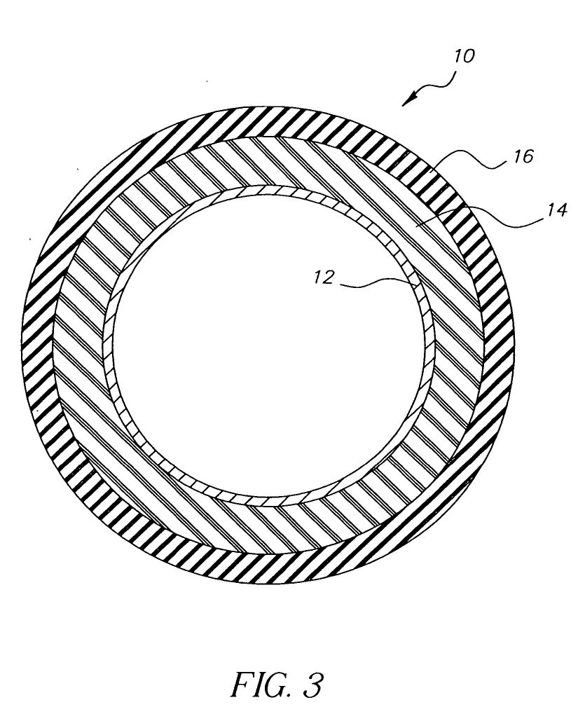

In the description of the Figures, the same numbers will be used throughout to refer to the same or similar components. Particularly with respect to FIG. 3, only those elements required to describe the present invention will be discussed. Unless otherwise indicated, all parts and percentages are by weight and temperatures are in degrees Centigrade (C).

According to the present invention, as shown in FIG. 1, substrates or recording elements 24 bearing ink jet or other printed ink images may be passed along a belt or other conveyor system 22 past a dryer shown schematically at 26, a set of drying rollers 20, a second set of dryers 28 and finally between a fuser roller 30 and a pressure roller 32. The substrates as shown are supported above the conveyor and may be dried at 28 by air drying, heat drying, infrared drying or the like as known to those skilled in the art. The drying may be continued to a desired point and is controlled to avoid bubbling or otherwise deforming the ink image. The substrate bearing the image is then passed between rollers 20 where addition drying is accomplished. The substrate may then be passed through a pair of dryers 28 and than passed between a fusing roller and a pressure roller to fuse the image. Such processes are particularly useful when fusable compounds such as polymeric materials as used as toner constituents in electrophotographic copying are included in the ink.

In the use of processes such as shown in FIG. 1, any one of the components may be used alone or in combination with the others. For instance, only a dryer 26 may be used in some instances. In such instances, the durability of the ink print is improved to a certain extent but not to the extent typically achieved by the use of polymeric inks that are subsequently fused. Similarly the use of the drying rollers 20, which are heated, may be used alone or in conjunction with first dryer 26. Similarly dryers 28, shown to illustrate heating from both sides of belt 22 and may be used alone. Similar results are achieved by this approach to the use of first dryer 26 alone. Any one of the first dryer 26, drying rollers 20 or dryers 28 can be used alone or in conjunction with fuser roller 30 and pressure roller 32. In other words, the print image is dried to the extent necessary to permit passage through the fusing step without damage to the ink print image. Typically most of the solvent and water is removed from the printed image prior to fusing between rollers 30 and 32.

By contrast to operations in electrophotographic copying wherein well known materials are used on the surfaces of rollers 30 and 32 and could be used on rollers 20, it has been found that the surface coatings usually used on such rollers are not effective to achieve desirable release properties in the drying and fusing of printed ink images.

Accordingly, a new composition has been developed for use in coating such rollers to achieve desired release properties. It is particularly important that rollers 20, which contact the print before the removal of substantial quantities of water or solvent liquids have desirable release properties. It is also important that fuser roller 30 and pressure roller 32 have desirable release properties, but it is anticipated that the difficulty in obtaining suitable release performance will be greater with the rollers 20 which contact the “wetter” ink print image.

It is believed that the use of the rollers as described in the present invention will be equally useful not only with ink jet images but with other ink print images, particularly those that include quantities of fusable polymers such as found in toners used in electrophotographic copying. With all such inks, the composition and roller of the present invention are considered to provide improved release properties as required for suitable process operation.

The present invention comprises a roller for use in treating a recording element bearing any ink jet image to improve at least one property of the ink image on the recording element. The roller comprises a metallic core having an outside and an outer coating around the outside of the metallic core and comprising a reaction product of: a high molecular weight reactive polyfunctional poly(alkylsiloxane) polymer which is a liquid blend at room temperature comprising about 60 to about 80 weight percent of a difunctional poly(dialkylsiloxane) having a number average molecular weight from about 140,000 to about 150,000 and about 20 to about 40 weight percent of a poly(trialkyl)silyl silicate resin having monofunctional and tetrafunctional repeating units in an average ratio of between 0.8 to about 1 monofunctional unit per each tetrafunctional unit (0.8-1.0) to 1, and having a number average molecular weight from about 1,500 to about 2,500; at least one cross-linkable vinyl-substituted poly(dialkylsiloxane) with a weight-average molecular weight before cross-linking from about 1,000 to about 90,000; about 1 to about 5 parts by weight per 100 parts by weight of poly(dialkylsiloxane) finely divided filler; at least one cross-linking agent comprising a multifunctional organo-hydrosiloxane having hydride functional groups capable of reacting with the vinyl functional groups of the poly(dialkylsiloxane); and at least one cross-linking catalyst present in an amount sufficient to catalyze addition polymerization of the vinyl-substituted poly(dialkylsiloxane) and the cross-linking agent.

This roller is coated with the reaction product that may overlie a core 12, which is preferably metal but could be a plastic or other material having a suitable strength, conductivity and high temperature tolerance and which may be hollow or cylindrical. Desirably the core is of any suitable metal having sufficient strength. The coating is desirably from about 0.4 mm to about 6 mm in thickness. The coating may also include fillers as will be discussed below.

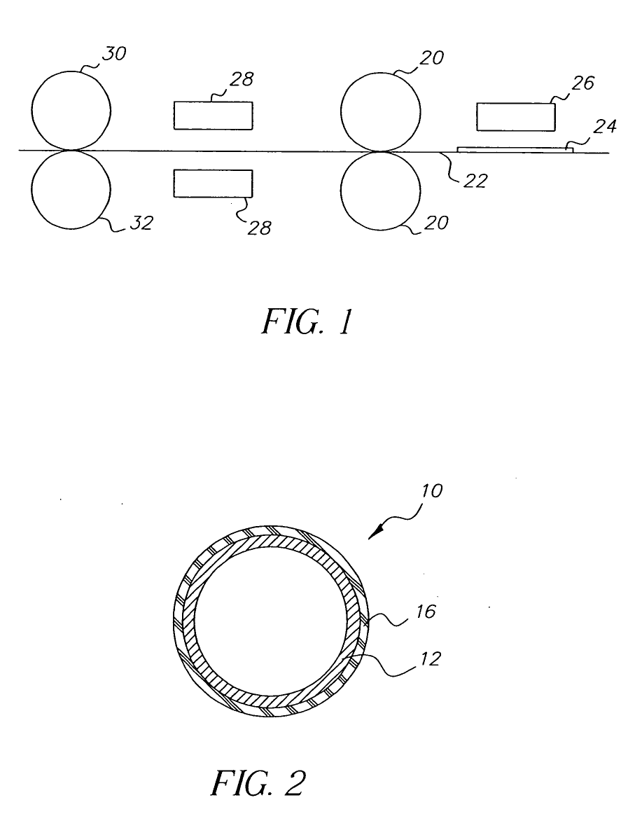

Such a roller is shown in FIG. 2 and includes a core 12 and an outer coating 16.

In FIG. 3, a further embodiment of the roller is shown. In the roller shown in FIG. 3, the roller includes a cushion layer 14 between the outside of core 12 and outer layer 16, which comprises the composition of the present invention.

The cushion roller is desirably a thermally conductive material such as a metal oxide filled silicone elastomer. Such coatings are well known to those skilled in the art. Typically, such coatings are of a thickness from about 0.5 mm to about 6 mm thick. It is desirable that such cushion layers be thermally conductive.

The use of rollers, such as shown in the Figures is particularly effective to enable the high throughput of photographic quality, durable prints for medical, diagnostic and photo printing applications. These systems provide good release and durable characteristics for the recording substrate when converting a print image when the ink includes fusable ink receiving images.

The cross-linked poly(dialkylsiloxane) can be formed by addition polymerization of vinyl-substituted multifunctional siloxane polymers with multifunctional organo-hydrosiloxanes, as is generally described in U.S. Pat. Nos. 5,587,245 and 6,020,038, which are hereby incorporated in their entirety by reference. Vinyl-substituted multifunctional siloxane polymers and their preparation are known and, as used in the present invention, preferably have at least one of the following repeating subunits:
and terminal subunits having the general structure:

Designations, such as Z′, R, and L, in the foregoing and all 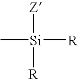
structural formulas herein; are used in a uniform manner and have the following meanings:

R is an alkyl containing from 1 to 8 carbon atoms. More preferred are alkyl groups containing from 1 to 6 carbon atoms. Specific examples of R groups include: methyl, ethyl, propyl, and butyl, with methyl being most preferred. R groups can be substituted, however, the substituents should not degrade the characteristics of the resulting polymer. For example, R groups that react with olefins or organo-hydrosiloxanes are undesirable. Although minor amounts of aryl functionality can be incorporated into the polymer, it is generally not desirable to add a significant amount of aryl functionality into the poly(dialkylsiloxane) polymer, as the aryl functionality can inhibit the swelling of release agent.

Z is an olefinic group containing from 2 to 8 carbon atoms and a terminal vinyl moiety. Specific examples of Z groups include vinyl and allyl.

Z′ represents Z or R, provided that each molecule of vinyl-substituted multifunctional siloxane polymer has two or more Z moieties (and thus 2 or more terminal vinyl groups).

L is —O— or —(CH₂)ₑ—, where e is an integer from 1 to about 8.

The vinyl-substituted multifunctional siloxane polymers can be represented, at least in so far as the currently preferred embodiments of the invention, by the general structure (referred to herein as “structure I”):

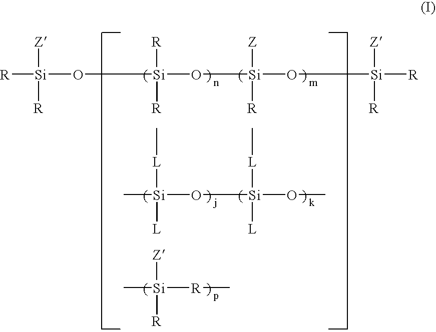

Each repeating subunit that has one or more L moieties represents a branch point. Branches may extend outward in the form of a dendrite or star, or may form cross-links to other chains. The value of p, the number of terminal units on branches, is equal to or less than the total number of branching units, j+2k, and may be as low as zero if all branching subunits form cross-links.

The extent of branching or cross-linking of the siloxane polymer is low, since the resulting elastomer would otherwise be excessively hard. If n+m+j+k is defined as being equal to 100 mole percent; then j+k is less than 5 mole percent, and preferably is from about 2 to 0 mole percent. The latter represents a preferred siloxane polymer, in which branching subunits are completely or substantially excluded. For this polymer, structure I can be simplified to the following (structure II):

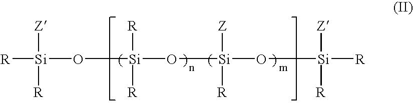

The siloxane polymer has at least two olefinic functionalities (in structures I or II; Z, or Z′, or a combination of Z and Z′). The percentage of silicon atoms substituted by an olefinic moiety can be higher than two, but must be low enough to prevent the resulting elastomer from being excessively hard due to extensive cross-linking. It is preferred that the percentage of silicon atoms substituted by an olefinic moiety is less than about 3 percent of the total number of silicon atoms; or, more preferably, less than about 2 percent of the total number of silicon atoms.

According to the invention, the value of m is 0 or 1 and Z′ is olefinic. In one such embodiment, structure II can be simplified as (structure III):

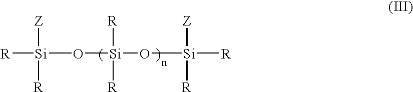

In other embodiments of the invention, Z′ is R. In one such embodiment, structure II can be simplified as (structure IV):

In particular embodiments of the invention, Z or Z′ groups each have the general structure:

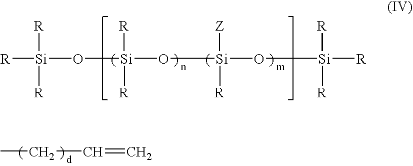

Where d is an integer from 0 to about 6 and preferably from 0 to about 3. In one such embodiment, the siloxane polymer has the general structure (structure V):

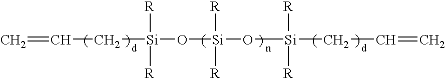

A specific example of such a preferred poly(dialkylsiloxane) polymer is a vinyldimethyl-terminated polydimethylsiloxane, which has the general structure: 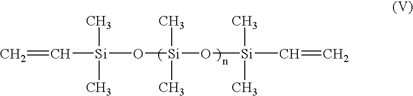
and a weight-average molecular weight of about 1,000 to about 90,000. These materials are commercially available from United Chemical Technologies, Inc., Piscataway, N.J., under various designations depending upon the viscosity and molecular weight desired.

In another embodiment, the siloxane polymer has the general structure (structure VI):

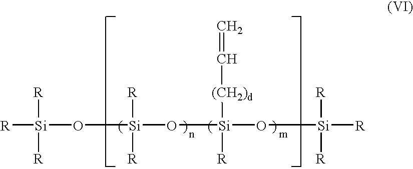

The designations n, m, and d have the same meanings as given above. A specific example of such a siloxane polymer is vinylmethyl siloxane copolymers in which each R is methyl.

In the structural formulas above, the values of n, or n+m, or n+m+j+k, are integers such that the respective polymer has a weight average molecular weight between vinyl groups of from 1,000 to 90,000. If the molecular weight between vinyl groups is above 90,000, the final cross-linked polymer would be too unstable under conditions of high temperature and cyclic stress (i.e., there would be too much creep and change in hardness over time), even when filler is dispersed therein in accordance with the invention. If the molecular weight between vinyl groups is below 1,000, the final cross-linked elastomer would have a cross-link density that is too high and would make the material too hard and brittle.

The multifunctional organo-hydrosiloxanes that serve as cross-linking agents for the structure I polymers have the general structure (structure VII): 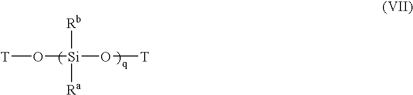
Each T represents: 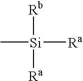
or both T's together represent atoms completing an organo-hydrosiloxane ring, such that structure VII can be rewritten as:

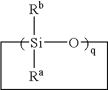

R^{a} represents the same groups as R, i.e., R^{a} can be an alkyl having from 1 to 8 carbon atoms. Specific examples of R^{a} groups include: methyl, ethyl, propyl, and butyl. R^{b} represents H or R^{a}. At least two R^{b} moieties are H. It is preferred that R^{a} be methyl and that T be trimethylsilyl. The value of q is preferably from 3 to about 300. A specific example of a suitable multifunctional organo-hydrosiloxane is a material marketed under the trademark PS123, by United Chemical Technologies, Piscataway, N.J. This material has the general structure:

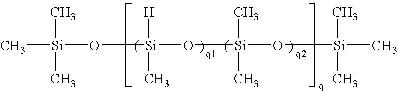

Where q¹+q²=q, and has a weight average molecular weight of from about 2,000 to 2,500. Another example is 1,3,5,7-tetramethylcyclotetrasiloxane, also available from United Chemical Technologies.

The addition cross-linking reaction is carried out with the aid of a late transition metal catalyst as known to the art, such as cobalt, rhodium, nickel, palladium or platinum catalysts. Specific examples of such catalysts include chlorotris(triphenylphosphine)rhodium(I), RhCl(Ph₃P)₃; dicobaltoctacarbonyl, CO₂(Co)₈; and chloroplatinic acid, H₂PtCl₆. Chloroplatinic acid is preferred. In a particular embodiment of the invention, the catalyst is added as a complex with vinyl-terminated polysiloxane. Currently preferred is a platinum catalyst complex sold commercially under the trademark PC075 by United Chemical Technologies. This material is a complex of chloroplatinic acid and cyclovinylmethyl siloxane and has a platinum concentration of 2 to 3.5 percent by weight based on the total weight of the mixture to be cured. It is also preferred that the PC075 complex be diluted with vinyl-terminated dimethylsiloxane polymer to provide a diluted platinum concentration of from 0.1 to 1000 parts per million (ppm), depending upon the desired cure rate. A suitable polysiloxane diluent is marketed by United Chemical Technologies as PS441.2 (viscosity=200 cts).

In preferred embodiments, the converting roller outer layer 16 comprises two components. The first component comprises the cross-linked, addition-polymerized reaction product of a vinyl-terminated poly(dialkylsiloxane) and hydride-functional (Si—H) poly(dimethylsiloxane), provided that the molar ratio of vinyl to Si—H functional groups is from about 0.5:1 to about 5:1. The reaction is preferably conducted in the presence of a platinum curing catalyst with a weight ratio of platinum catalyst to poly(dialkylsiloxane) of from about 1×10⁻³ to 1 to about 1×10⁻⁶ to 1.

The first component also contains a filler that can be selected from inorganic metal oxides, such as aluminum oxide, iron oxide, tin oxide, zinc oxide, copper oxide and nickel oxide. Silica (silicon dioxide) can also be used. The particle size of the filler does not appear to be critical. Particle sizes anywhere in the range of 0.1 to 100 micrometers are acceptable. The amount of filler employed is described above. The filler particles are preferably mixed with the starting polymer and multifunctional organo-hydrosiloxane cross-linking agent prior to curing the mixture on base member 16.

A preferred commercially available material for forming a cross-linked, addition-polymerized, polyorganosiloxane is GE862 silicone rubber available from GE Silicones, Waterford, N.Y. or S5100 silicone rubber available from Emerson Cumming Silicones Division of W. R. Grace and Co. Of Lexington, Mass.

The second component of the outermost layer is a high molecular weight reactive polyfunctional poly(alkylsiloxane) polymer. The high molecular weight reactive polyfunctional poly(alkylsiloxane) polymer has repeating units of the formula,
(R¹ₐSiO_{(4-a)/2};
Where R¹ is an alkyl group containing from about 1 to about 6 carbon atoms and is 0-3.

Further, the high molecular weight reactive polyfunctional poly(alkylsiloxane) polymer is a liquid blend comprising about 60 to 80 weight percent of a difunctional poly(dialkylsiloxane) having a number average molecular weight from about 140,000 to about 150,000 and about 20 to about 40 weight percent of a poly(trialkyl)silyl silicate resin having monofunctional and tetrafunctional repeating units in an average ratio of between (0.8-1.0) to 1, and having a number average molecular weight from about 1,500 to about 2,500 and preferably about 2,200. The alkyl groups in both the reactive polyfunctional poly(alkylsiloxane) polymer and the difunctional poly(dialkylsiloxane) contain from 1 to about 6 carbon atoms.

In a preferred embodiment, the various components of the composite material can have the following weight percentages: (a) 50% to 80% by weight of at least one cross-linkable, poly(dialkylsiloxane), wherein the poly(dialkylsiloxane) is a vinyl-substituted poly alkylsiloxane with terminal and/or pendant vinyl group functionality and a weight-average molecular weight before cross-linking of about 1,000 to about 90,000; (b) from about 1 to less than 5 weight percent of the poly dialkylsiloxane) of finely divided filler; (c) 10 to 30 weight % of at least one cross-linking agent comprising a multifunctional organo-hydrosiloxane having hydride functional groups (Si—H) capable of reacting with the vinyl functional groups of the poly(dialkylsiloxane); (d) at least one cross-linking catalyst present in an amount sufficient to catalyze addition polymerization of the poly(dialkylsiloxane) with the organo-hydrosiloxane cross-linking agent; and, (e) 5 to 20 wt % high molecular weight reactive polyfunctional poly(alkylsiloxane) polymer;

Components (a) through (d) are considered to be an addition cure polysiloxane component and the high molecular weight reactive polyfunctional poly(alkylsiloxane) is a high molecular weight component.

To form the outer coating 16 of roller 12 of FIG. 2 in accordance with the invention, at least one vinyl-substituted poly(dialkylsiloxane), a stoichiometric excess amount of multifunctional silane to form cross-links with the vinyl end groups of the vinyl-substituted poly(dialkylsiloxane), the high molecular weight reactive polyfunctional poly(alkylsiloxane) polymer and an appropriate amount of filler as previously described are thoroughly mixed by any suitable method, such as with a three-roll mill as known to the art. The mixture is then degassed and injected into a mold surrounding the base member, e.g. roller, or core to mold the material onto the core either with or without a base cushion layer, according to injection molding methods well known in the art. The so-treated core is kept in the mold for a time sufficient for some cross-linking to occur (e.g., generally at least about 4 hours) and allow the core to be removed from the mold without damage thereto. The so-coated roller is then removed from the mold and maintained at a temperature of from about 25 to about 100° C. for at least about 1 hour to substantially complete the reaction and/or accelerate remaining cross-linking.

Alternately the mix can be applied to the core by methods other than molding known to those skilled in the art.

It is currently optional to apply the base cushion layer 14 over the metallic core 12 which has been conversion coated and primed with metal alkoxide primer in accordance with commonly assigned U.S. Pat. No. 5,474,821, which is herby incorporated in its entirety by reference. Then the outer layer 16 is coated over base cushion layer 14. One or more methods of layer-to-layer adhesion improvement, such as corona discharge treatment of the underlying coating layer's surface, may be applied prior to application of the material of this invention. Various methods of layer-to-layer adhesion improvement are well known to one skilled in the art.

The following examples are presented for a further understanding of the invention. The examples are illustrative of specific embodiments of the present and should not be constructed as limiting the scope thereof.

### EXAMPLE 1

One-hundred grams of STYCAST 5100 A (a vinyl functionalized, cross-linked poly(dimethylsiloxane), incorporating an oxide, is mixed with 100 parts of S5100 B (A Si—H functionalized, cross-linked polydimethylsiloxane used as curing agent. Both are trademarks of and obtainable from Emerson Cumming Silicone division of W.R. Grace and Co., Lexington, Mass.

The resulting mixture was blended with 10 g of SFR-100 (a trademark of GE silicones) high molecular weight reactive polyfunctional poly(alkylsiloxane) polymer. The silicone mixture is then degassed and is then ready for injection mold.

The S5100 A base compound contains a vinyl-terminated poly(dimethylsiloxane) polymer with an effective amount, i.e., believed to be 10 to 100 ppm, of platinum as catalyst therein to initiate addition polymerization with a hydride-terminated siloxane polymer in the S5100 B curing agent, and also about 3 wt % of silica as filler per 100 parts of S5100 A and S5100 B are used. The cross-linking agent is a hydride-terminated siloxane.

The S5100 B curing agent contains a vinyl-terminated poly(dimethylsiloxane) and a slight molar excess of hydride-terminated poly(dimethylsiloxane) to substantially react with the vinyl groups of the poly(dimethylsiloxane) in both the S5100 A base compound and the S5100 B curing agent.

### EXAMPLE 2

Preparation of Converting Roller:

A cylindrical aluminum core is initially cleaned with dichloromethane and dried. The outer surface of the core is then primed with a uniform coat of a metal alkoxide prime coat primer that contains light aliphatic petroleum naptha (85 weight percent), tetra(2-methoxyethoxy)-silane (5 weight percent), tetrapropyl orthosilicate (5 weight percent), and tetrabutyl titanate (5 weight percent), i.e., Dow 1200. Dow 1200 is a trademark and marketed by Dow Corning Corporation of Midland, Mich. The core is then air-dried.

The silicone mixture from Example 1 is then injection molded into a mold around the outside of the core, according to conventional injection molding methods and the mold is maintained at room temperature for 24 hours. The core is then removed from the mold and placed in an oven wherein the temperature therein is ramped to 80 C over a period of 30 minutes, followed by a one hour hold at 80 C to substantially complete cross-linking of the silicone mixture. The resulting converting roller has a poly(dimethylsiloxane) outer layer with a dried thickness of 0.200 inches.

As well known to those skilled in the art, fusing techniques and equipment used to fuse toner images in the electrophotographic copying and production of documents containing fused toner images involves the use of significantly different materials than are used in the ink jet and other ink printing applications. Specifically the toner comprises a dry polymeric material that is electrostatically positioned on a substrate until fused. By contrast, ink jet printing images or other images containing ink constituents that basically comprise carriers and the like that carry the image-forming materials in a volatile mixture. Even when such materials are modified to include toner-like polymeric materials that are fusable, the materials still contain significant quantities of volatile materials. To some extent these materials can be removed by heating methods, such as infrared, convection heating, air blowing or the like. Each of these drying methods has certain disadvantages. In any event, printed images are frequently dried. In some instances drying is partly accomplished by pairs of rollers. In many instances when fusable materials are included in the inks, the ink images are improved significantly in their stability by fusing.

The rollers used for such operations must release cleanly from the surface of the substrates bearing the ink images as the operations are completed. It has been found that many of the rollers used in fusing operations with toner images do not release well from ink images. Accordingly, the present invention is directed to the preparation of rollers and a composition for their outer surface that release well from ink images on a substrate.

While the present invention has been described by reference to certain of its preferred embodiments, it is pointed out that the embodiments described are illustrative rather than limiting in nature and that many variations and modifications are possible within the scope of the present invention.

1. A roller for use in treating a recording element bearing an ink image to improve at least one property of an ink jet image on the recording element, the roller comprising:
a) a metallic core having an outside surface and;
b) an outer coating around the outside surface of the metallic core and comprising a reaction produce of:
i) a high molecular weight reactive polyfunctional poly(alkylsiloxane) polymer which is a liquid blend at 25° C. comprising from about 60 to about 80 weight percent of a difunctional poly(dialkylsiloxane) polymer having a number average molecular weight from about 140,000 to about 150,000, and from about 20 to about 40 weight percent of a poly(trialkyl)silyl silicate resin having monofunctional and tetrafunctional repeating units in an average ratio of between 0.8 to about 1 monofunctional unit per each tetrafunctional unit (0.8-1.0) to 1, and having a number average molecular weight from about 1,500 to about 2,500;
ii) at least one cross-linkable vinyl-substituted poly(dialkylsiloxane) with a weight-average molecular weight before cross-linking from about 1,000 to about 90,000;
iii) about 1 to about 5 parts by weight per 100 parts by weight of polydiakylsiloxane finely divided filler;
iv) at least one cross-linking agent comprising a multifunctional organo-hydrosiloxane having hydride functional groups capable of reacting with the vinyl functional groups of the vinyl-substituted poly(dialkylsiloxane); and
v) at least one cross-linking catalyst present in an amount sufficient to catalyze addition polymerization of the vinyl-substituted poly(dialkylsiloxane) and the cross-linking agent.

2. The roller of claim 1, wherein the filler is an inorganic metal oxide.

3. The roller of claim 2, wherein the filler is selected from the group consisting of aluminum oxide, iron oxide, tin oxide, zinc oxide, copper oxide, nickel oxide, silicon dioxide and combinations thereof.

4. The roller of claim 1, wherein the cross-linkable vinyl substituted poly(dialkylsiloxane) comprises an addition cure polysiloxane component.

5. The roller of claim 1, wherein the difunctional poly(dialkylsiloxane) polymer contains alkyl groups containing from 1 to about 6 carbon atoms.

6. The roller of claim 1, wherein the poly(trialkyl)silyl silicate contains alkyl groups containing 1 to about 6 carbon atoms.

7. The roller of claim 1, wherein the vinyl-substituted poly(dialkylsiloxane) contains alkyl groups containing from 1 to about 8 carbon atoms.

8. The roller of claim 1, wherein the vinyl-substituted poly(dialkylsiloxane) contains at least one of the subunits: 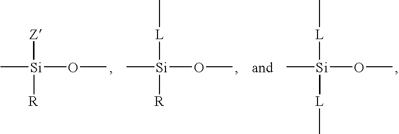
and terminal subunits having the general structure: 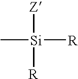
wherein designations, such as Z′, R, and L, have the following meanings:
R is an alkyl containing from 1 to about 8 carbon atoms. Preferred alkyl groups contain from 1 to about 6 carbons. Specific examples of R groups include: methyl, ethyl, propyl, and butyl, with methyl being most preferred. R groups can be substituted, however, the substituents should not degrade the characteristics of the resulting polymer. For example, R groups that react with olefins or organo-hydrosiloxanes are undesirable. Although minor amounts of aryl functionality can be incorporated into the polymer, it is generally not desirable to add a significant amount of aryl functionality into the poly(dialkylsiloxane) polymer, as the aryl functionality can inhibit the swelling of release agent;
Z′ represents Z or R, provided that each molecule of vinyl-substituted multifunctional siloxane polymer has two or more Z moieties (and thus 2 or more terminal vinyl groups); and,
L is —O— or —(CH₂)ₑ—, where e is an integer from 1 to about 8.

9. The roller of claim 1, wherein the cross-linkable vinyl-substituted poly(dialkylsiloxane) has a general formula: 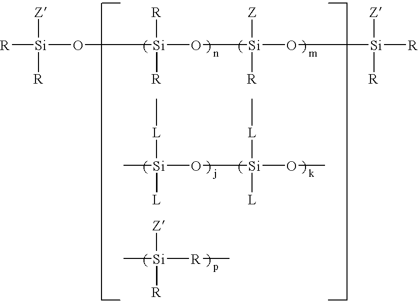
wherein designations, Z, Z′, R, and L have the following meanings:
R is an alkyl containing from 1 to about 8 carbon atoms. Preferred alkyl groups contain from 1 to about 6 carbons. Specific examples of R groups include: methyl, ethyl, propyl, and butyl, with methyl being most preferred. R groups can be substituted, however, the substituents should not degrade the characteristics of the resulting polymer. For example, R groups that react with olefins or organo-hydrosiloxanes are undesirable. Although minor amounts of aryl functionality can be incorporated into the polymer, it is generally not desirable to add a significant amount of aryl functionality into the poly(dialkylsiloxane) polymer, as the aryl functionality can inhibit the swelling of release agent;
Z is an olefinic group having from 2 to about 8 carbons and a terminal vinyl moiety. Specific examples of Z groups include vinyl and allyl;
Z′ represents Z or R, provided that each molecule of vinyl-substituted multifunctional siloxane polymer has two or more Z moieties (and thus 2 or more terminal vinyl groups); and,
L is —O— or —(CH₂)ₑ—, where e is an integer from 1 to about 8.

10. The roller of claim 1, wherein the cross-linking catalyst comprises at least one of cobalt, rhodium, nickel, palladium and platinum.

11. The roller of claim 10, wherein the cross-linking catalyst is selected from the group consisting of chlorotris(triphenylphosphine)rhodium, dicobaltoctacarbonyl, and chloroplatinic acid.

12. The roller of claim 11, wherein the cross-linking catalyst is chloroplatinic acid.

13. The roller of claim 1, wherein the outer coating has a thickness from about 0.01 mm to about 0.08 mm.

14. The roller of claim 1, wherein the roller includes a cushion layer positioned around the outside of the metallic core and inside the outer coating.

15. The roller of claim 14, wherein the cushion layer has a thickness from about 8 mm to about 40 mm.

16. The roller of claim 14, wherein the cushion layer comprises a metal oxide filled silicone elastomer.

17. A composition comprising a reaction product of:
a) a high molecular weight reactive polyfunctional poly(alkylsiloxane) polymer which is a liquid blend at 25° C. comprising about 60 to about 80 weight percent of a difunctional poly(dialkylsiloxane) polymer having a number average molecular weight from about 140,000 to about 150,000, and about 20 to about 40 weight percent of a poly(trialkyl)silyl silicate resin having monofunctional and tetrafunctional repeating units in an average ratio of between 0.8 to about 1 monofunctional unit per each tetrafunctional unit (0.8-1.0) to 1, and having a number average molecular weight from about 1,500 to about 2,500;
b) at least one cross-linkable vinyl-substituted poly(dialkylsiloxane) with a weight-average molecular weight before cross-linking of about 1,000 to about 90,000;
c) about 1 to about 5 parts by weight per 100 parts by weight of polydiaklysiloxane finely divided filler;
d) at least one cross-linking agent comprising a multifunctional organo-hydrosiloxane having hydride functional groups capable of reacting with the vinyl functional groups of the vinyl-substituted poly(dialkylsiloxane); and,
e) at least one cross-linking catalyst present in an amount sufficient to catalyze addition polymerization of the vinyl-substituted poly(dialkylsiloxane) and the cross-linking agent.

18. The composition of claim 17, wherein the filler is an inorganic metal oxide.

19. The composition of claim 18, wherein the filler is selected from the group consisting of aluminum oxide, iron oxide, tin oxide, zinc oxide, copper oxide, nickel oxide, silicon dioxide and combinations thereof.

20. The composition of claim 17, wherein the cross-linkable vinyl substituted poly(dialkylsiloxane) comprises an addition al cure polysiloxane component.

21. The composition of claim 17, wherein the difunctional poly(dialkylsiloxane) polymer contains alkyl groups containing from 1 to about 6 carbon atoms.

22. The composition of claim 17, wherein the poly trialkyl silyl silicate contains alkyl groups containing 1 to about 6 carbon atoms.

23. The composition of claim 17, wherein the vinyl-substituted poly(dialkylsiloxane) contains alkyl groups containing from 1 to about 8 carbon atoms.

24. The composition of claim 17, wherein the vinyl-substituted poly(dialkylsiloxane) contains at least one of the subunits: 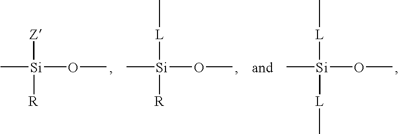
wherein designations, such as Z′, R, and L, have the following meanings:
R is an alkyl containing from 1 to about 8 carbon atoms. Preferred alkyl groups contain from 1 to about 6 carbons. Specific examples of R groups include: methyl, ethyl, propyl, and butyl, with methyl being most preferred. R groups can be substituted, however, the substituents should not degrade the characteristics of the resulting polymer. For example, R groups that react with olefins or organo-hydrosiloxanes are undesirable. Although minor amounts of aryl functionality can be incorporated into the polymer, it is generally not desirable to add a significant amount of aryl functionality into the poly(dialkylsiloxane) polymer, as the aryl functionality can inhibit the swelling of release agent;
Z′ represents Z or R, provided that each molecule of vinyl-substituted multifunctional siloxane polymer has two or more Z moieties (and thus 2 or more terminal vinyl groups); and,
L is —O— or —(CH₂)ₑ—, where e is an integer from 1 to about 8.

25. The composition of claim 17, wherein the cross-linkable vinyl-substituted poly(dialkylsiloxane) has a general formula: 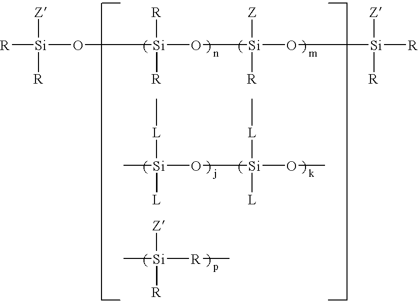
wherein designations, Z, Z′, R, and L have the following meanings:
R is an alkyl containing from 1 to about 8 carbon atoms. Preferred alkyl groups contain from 1 to about 6 carbons. Specific examples of R groups include: methyl, ethyl, propyl, and butyl, with methyl being most preferred. R groups can be substituted, however, the substituents should not degrade the characteristics of the resulting polymer. For example, R groups that react with olefins or organo-hydrosiloxanes are undesirable. Although minor amounts of aryl functionality can be incorporated into the polymer, it is generally not desirable to add a significant amount of aryl functionality into the poly(dialkylsiloxane) polymer, as the aryl functionality can inhibit the swelling of release agent;
Z is an olefinic group having from 2 to about 8 carbons and a terminal vinyl moiety. Specific examples of Z groups include vinyl and allyl;
Z′ represents Z or R, provided that each molecule of vinyl-substituted multifunctional siloxane polymer has two or more Z moieties (and thus 2 or more terminal vinyl groups); and,
L is —O— or —(CH₂)ₑ—, where e is an integer from 1 to about 8.

26. The composition of claim 17, wherein the cross-linking catalyst comprises at least one of cobalt, rhodium, nickel, palladium and platinum.

27. The composition of claim 26, wherein the cross-linking catalyst is selected from the group consisting of chlorotris(triphenylphosphine) rhodium, dicobaltoctacarbonyl, and chloroplatinic acid.

28. The composition of claim 27, wherein the cross-linking catalyst is chloroplatinic acid.
